(19) United States
(12) Patent Application Publication
(10) Pub. No.: US 2026/0045979 A1
(43) Pub. Date: Feb. 12, 2026

(54) PRECODING MATRIX DETERMINATION METHOD AND APPARATUS FOR UPLINK MIMO TRANSMISSION

(71) Applicant: Beijing Xiaomi Mobile Software Co., Ltd., Beijing (CN)

(72) Inventors: Zhenyu ZHANG, Beijing (CN); Xueyuan GAO, Beijing (CN)

(73) Assignee: Beijing Xiaomi Mobile Software Co., Ltd., Beijing (CN)

(21) Appl. No.: 18/998,877

(22) PCT Filed: Aug. 4, 2022
(86) PCT No.: PCT/CN2022/110385

§ 371 Date: Jan. 27, 2025

(51) Int. Cl. H04B 7/0456; H04B 7/06; H04L 5/00

(52) U.S. Cl. CPC H04B 7/0456; H04B 7/0626; H04L 5/0048

(57) ABSTRACT

Disclosed in the embodiments of the present disclosure are precoding matrix determination methods and apparatus for uplink MIMO transmission, which can be applied to a communication system. A method includes: receiving a CSI-RS of 8 antenna ports sent by a network device; determining a target codeword coefficient adaptive to the current channel state according to the CSI-RS, and sending to the network device the target codeword coefficient; sending to the network device a SRS of the 8 antenna ports, receiving indication information sent by the network device for indication a target precoding matrix required for uplink transmission, the target precoding being determined according to the target codeword coefficient and the SRS; and further precoding data according to the target precoding matrix, and sending same to the network device.

### CROSS-REFERENCE TO RELATED APPLICATIONS

The present application is a U.S. National Stage of International Application No. PCT/CN2022/110385, filed on Aug. 4, 2022, the content of which is incorporated herein by reference in its entirety for all purposes.

### TECHNICAL FIELD

The present disclosure relates to a precoding matrix determination method and apparatus for uplink multiple input multiple output (MIMO) transmission.

### BACKGROUND

Precoding technology in MIMO systems may effectively reduce interference and system overhead, and enhance system capacity. It is an extremely important key technology in MIMO systems. In MIMO systems based on codebook transmission, codebook design is also an important part of precoding technology.

### SUMMARY

The embodiments of the present disclosure relate to the field of communication technology, and provide a precoding matrix determination method and apparatus for uplink MIMO transmission.

In the first aspect, the embodiments of the present disclosure provide a precoding matrix determination method for uplink MIMO transmission, the method including:
receiving a channel status information reference signal (CSI-RS) of 8-antenna ports sent by a network device;
determining a target codeword coefficient adaptive to a current channel state according to the CSI-RS, and sending the target codeword coefficient to the network device;
sending a sounding reference signal (SRS) of 8-antenna ports to the network device;
receiving indication information sent by the network device, where the indication information indicates a target precoding matrix required for uplink transmission, the target precoding being determined according to the target codeword coefficient and the SRS;
precoding data according to the target precoding matrix, and sending to the network device.

In the embodiments of the present disclosure, a CSI-RS of 8-antenna ports sent by a network device is received, a target codeword coefficient adaptive to a current channel state according to the CSI-RS is determined and sent the target codeword coefficient to the network device, an SRS of 8-antenna ports is sent to the network device, indication information indicating a target precoding matrix required for uplink transmission sent by the network device is received, where the target precoding matrix is determined according to the target codeword coefficient and the SRS, further data according to the target precoding matrix is pre-coded and sent to the network device.

In the second aspect, the embodiments of the present disclosure provide a precoding matrix determination method for uplink MIMO transmission, the method including:
sending a CSI-RS of 8-antenna ports to a terminal;
receiving a target codeword coefficient sent by the terminal, where the target codeword coefficient is a codeword coefficient adaptive to a current channel state determined according to the CSI-RS;
receiving an SRS of 8-antenna ports sent by the terminal;
sending indication information to the terminal according to the target codeword coefficient and the SRS, where the indication information indicates a target precoding matrix required for uplink transmission;
receiving data sent by the terminal after precoding according to the target precoding matrix.

In the third aspect, the embodiments of the present disclosure provide a communication apparatus. The communication apparatus has some or all of the functions of the network device in the method described in the second aspect above. For example, the functions of the communication apparatus may have some or all of the functions in the embodiments of the present disclosure, or may have the function of implementing any one of the embodiments of the present disclosure independently. The functions may be implemented by hardware or by the hardware executing corresponding software. The hardware or software includes one or more units or modules corresponding to the above functions.

In one implementation, the structure of the communication apparatus may include a transceiver module and a processing module. The processing module is configured to support the communication apparatus to perform the corresponding functions in the above-mentioned method. The transceiver module is used to support the communication between the communication apparatus and other devices. The communication apparatus may also include a storage module, which is used to couple with the transceiver module and the processing module, and stores the necessary computer programs and data of the communication apparatus.

As an example, the processing module may be a processor, the transceiver module may be a transceiver or a communication interface, and the storage module may be a memory.

In the fourth aspect, the embodiments of the present disclosure provide a communication apparatus. The communication apparatus has some or all of the functions of the terminal in the method described in the first aspect above. For example, the functions of the communication apparatus may have some or all of the functions in the embodiments of the present disclosure, or may have the function of implementing any one of the embodiments of the present disclosure independently. The functions may be implemented by hardware or by the hardware executing corresponding software. The hardware or software includes one or more units or modules corresponding to the above functions.

In one implementation, the structure of the communication apparatus may include a transceiver module and a processing module. The processing module is configured to support the communication apparatus to perform the corresponding functions in the above-mentioned method. The transceiver module is used to support the communication between the communication apparatus and other devices. The communication apparatus may also include a storage module, which is used to couple with the transceiver module and the processing module, and stores the necessary computer programs and data of the communication apparatus.

As an example, the processing module may be a processor, the transceiver module may be a transceiver or a communication interface, and the storage module may be a memory.

In the fifth aspect, the embodiments of the present disclosure provide a communication apparatus. The communication apparatus includes a processor. When the processor calls the computer program in the memory, the method described in the first aspect above is executed.

In the sixth aspect, the embodiments of the present disclosure provide a communication apparatus. The communication apparatus includes a processor. When the processor calls the computer program in the memory, the method described in the second aspect above is executed.

In the seventh aspect, the embodiments of the present disclosure provide a communication apparatus. The communication apparatus includes a processor and a memory, there being stored computer programs in the memory. The processor executes the computer programs stored in the memory, so that the communication apparatus implements the method described in the first aspect above.

In the eighth aspect, the embodiments of the present disclosure provide a communication apparatus. The communication apparatus includes a processor and a memory, there being stored computer programs in the memory. The processor executes the computer programs stored in the memory, so that the communication apparatus implements the method described in the second aspect above.

In the nineth aspect, the embodiments of the present disclosure provide a communication apparatus. The apparatus includes a processor and an interface circuit. The interface circuit is used to receive code instructions and transmit them to the processor. The processor is used to execute the code instructions for the apparatus to implement the method described in the first aspect above.

In the tenth aspect, the embodiments of the present disclosure provide a communication apparatus. The apparatus includes a processor and an interface circuit. The interface circuit is used to receive code instructions and transmit them to the processor. The processor is used to execute the code instructions for the apparatus to implement the method described in the second aspect above.

In the eleventh aspect, the embodiments of the present disclosure provide a non-transitory computer-readable storage medium, storing instructions for the terminal described above. When the instructions are executed, the method described in the first aspect above is implemented by the terminal.

In the twelfth aspect, the embodiments of the present disclosure provide a non-transitory computer-readable storage medium, storing instructions for the network device described above. When the instructions are executed, the method described in the second aspect above is implemented by the network device.

In the thirteenth aspect, the embodiments of the present disclosure provide a computer program product including computer programs. When the product is run on the computer, the method described in the first aspect above is implemented by the computer.

In the fourteenth aspect, the embodiments of the present disclosure provide a computer program product including computer programs. When the product is run on the computer, the method described in the second aspect above is implemented by the computer.

In the fifteenth aspect, the embodiments of the present disclosure provide a chip system. The chip system includes at least one processor and an interface, which is used to support the terminal to implement the functions involved in the first aspect, for example, determining or processing at least one of the data and information involved in the above-mentioned method. In a possible design, the chip system also includes a memory, which is used to store the necessary computer programs and data of the terminal. The chip system may be composed of chips or include chips and other discrete components.

In the sixteenth aspect, the embodiments of the present disclosure provide a chip system. The chip system includes at least one processor and an interface, which is used to support the terminal to implement the functions involved in the second aspect, for example, determining or processing at least one of the data and information involved in the above-mentioned method. In a possible design, the chip system also includes a memory, which is used to store the necessary computer programs and data of the terminal. The chip system may be composed of chips or include chips and other discrete components.

In the seventeenth aspect, the embodiments of the present disclosure provide a computer program. When the program is run on the computer, the method described in the first aspect above is implemented by the computer.

In the eighteenth aspect, the embodiments of the present disclosure provide a computer program. When the program is run on the computer, the method described in the second aspect above is implemented by the computer.

### BRIEF DESCRIPTION OF THE DRAWINGS

To more clearly illustrate the technical solutions in the embodiments of the present disclosure, the following will explain the accompanying drawings that are required in the embodiments of the present disclosure or the background technology.

FIG. 1 is a schematic diagram showing the architecture of a communication system provided by an embodiment of the present disclosure;

FIG. 2 is a flow diagram showing a precoding matrix determination method for uplink MIMO transmission provided by an embodiment of the present disclosure:

FIG. 3 is a flow diagram showing another precoding matrix determination method for uplink MIMO transmission provided by an embodiment of the present disclosure:

FIG. 4 is a flow diagram showing another precoding matrix determination method for uplink MIMO transmission provided by an embodiment of the present disclosure:

FIG. 5 is a flow diagram showing another precoding matrix determination method for uplink MIMO transmission provided by an embodiment of the present disclosure:

FIG. 6 is a flow diagram showing another precoding matrix determination method for uplink MIMO transmission provided by an embodiment of the present disclosure:

FIG. 7 is a flow diagram showing another precoding matrix determination method for uplink MIMO transmission provided by an embodiment of the present disclosure:

FIG. 8 is a schematic diagram showing the structure of a communication apparatus provided by an embodiment of the present disclosure:

FIG. 9 is a schematic diagram showing the structure of a communication apparatus provided by an embodiment of the present disclosure:

FIG. 10 a schematic diagram showing the structure of a chip provided by an embodiment of the present disclosure.

### DETAILED DESCRIPTION

Here the exemplary embodiments will be described in detail, and their examples are illustrated in the accompanying drawings. When referring to the drawings below; unless otherwise indicated, the same numbers in different drawings represent the same or similar elements. The embodiments described in the following exemplary embodiments do not represent all the embodiments consistent with the present disclosure. On the contrary, they are merely examples of apparatuses and methods consistent with some aspects of the present disclosure as detailed in the attached claims.

The terms used in the embodiments of the present disclosure are merely for the purpose of describing specific embodiments and are not intended to limit the present disclosure. The singular forms of “a”, “an” and “the” used in the embodiments of the present disclosure and the appended claims are also intended to include the plural forms, unless the context clearly indicates otherwise. It should also be understood that the term “and/or” used herein refers to and encompasses any and all possible combinations of one or more of the associated listed items.

It should be understood that although the terms “first”, “second”, “third”, etc. may be used in the present disclosure to describe various information, such information should not be limited to these terms. These terms are only used to distinguish information of the same type from each other. For example, without departing from the scope of the present disclosure, the “first information” may also be referred to as “second information”, and similarly, the “second information” may also be referred to as “first information”. Depending on the context, for instance, the word “if” used herein may be interpreted as “while”, “when”, or “in response to determining”. For the sake of simplicity and ease of understanding, in this article, when characterizing the size relationship, the terms “greater than” or “less than”, “higher than” or “lower than” are used. However, for those skilled in the art, it may be understood that the term “greater than” also includes the meaning of “greater than or equal to”, and the term “less than” also includes the meaning of “less than or equal to”: the term “higher than” includes the meaning of “higher than or equal to”, and the term “lower than” also includes the meaning of “lower than or equal to”.

To facilitate understanding, the terms involved in the present disclosure are introduced first.

The physical uplink shared channel (PUSCH) is used to carry data from the transport channel PUSCH.

Coherent transmission is defined as a capability of the UE. The coherent transmission capabilities of the UE include:

Full coherence transmission: all antenna ports may coherently transmit.

Partial coherence transmission: antenna ports within the same coherent transmission group may coherently transmit, while antenna ports in different coherent transmission groups cannot coherently transmit. Each coherent transmission group includes at least two antenna ports.

Non coherence transmission: no antenna port can coherently transmit.

Currently, the maximum number of antenna ports supported by the codewords in uplink MIMO transmission is 4. With the enhancement of transmission requirements and scenarios, uplink transmission may support more antenna ports and uplink transmission layers, that is, the number of antenna ports may increase from 4 to a maximum of 8-antenna ports. Correspondingly, the number of uplink transmission layers may change from 4 layers to L layers, for example, the value of L can be from 1 to 8. However, with the increase in the number of antenna ports and transmission layers, the number of codewords in the codebook will increase significantly, resulting in greater TPMI overhead. Therefore, when 8-port uplink MIMO transmission is supported, it is necessary to design a corresponding precoding matrix selection and indication scheme to meet the requirements of uplink MIMO enhancement.

The embodiments of the present disclosure provide a precoding matrix determination method and apparatus for uplink MIMO transmission. By performing uplink channel estimation through sounding reference signals (SRS), the target precoding matrix for the 8-antenna ports required for uplink transmission is determined, which may meet the needs for enhancing uplink MIMO transmission.

Through the precoding matrix determination method for uplink MIMO transmission disclosed by the embodiments of the present disclosure, the codewords applicable to the fully coherent transmission via the antenna in the communication system are determined. The following first describes the communication system applicable to the embodiments of the present disclosure.

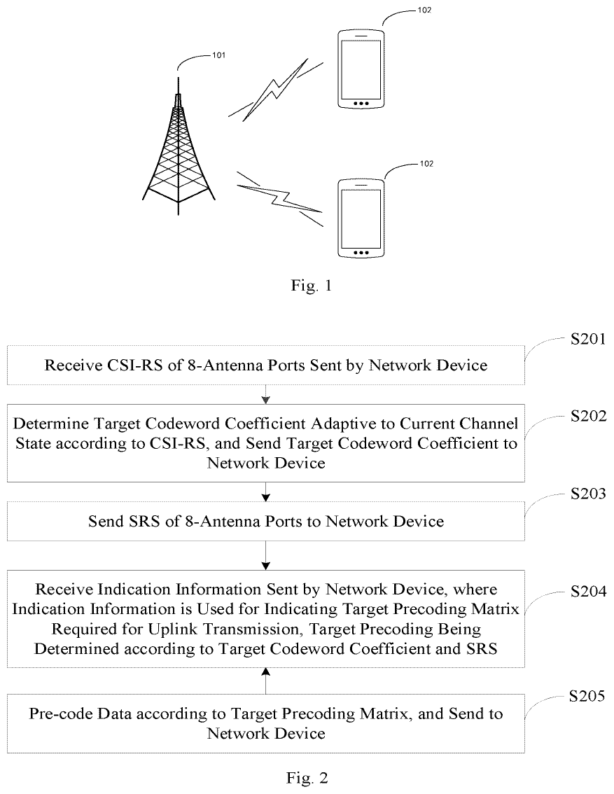

Please refer to FIG. 1. FIG. 1 is a schematic diagram showing the architecture of a communication system provided by an embodiment of the present disclosure. This communication system may include but is not limited to one network device and one terminal. The number and form of devices shown in FIG. 1 are only for illustration and do not constitute a limitation to the embodiment of the present disclosure. In practical applications, it may include two or more network devices and two or more terminals. The communication system shown in FIG. 1 takes the example of including one network device 101 and one terminal 102.

It should be noted that the technical solution of the embodiment of the present disclosure may be applied to various communication systems, for example, long term evolution (LTE) systems, 5th generation (5G) mobile communication systems, 5G new radio (NR) systems, or other future new mobile communication systems, etc. It should also be noted that the sidelink in the embodiments of the present disclosure may also be called a side-link or a direct link.

In the embodiments of the present disclosure, network device 101 is an entity on the network side for transmitting or receiving signals. For example, network device 101 may be an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure o not limit the specific technology and specific device form adopted by the network device. The network device provided in the embodiments of the present disclosure may be composed of a central unit (CU) and a distributed unit (DU). Among them, the CU may also be called a control unit. Adopting the structure of CU-DU may split the protocol layers of the network device, such as the base station. The functions of some protocol layers are centralized and controlled in the CU, and the functions of the remaining part or all protocol layers are distributed in the DU and are centralized and controlled by the CU.

In the embodiments of the present disclosure, terminal 102 is an entity for receiving or transmitting signals on the user side, such as a mobile phone. Terminals may also be referred to as terminals, user equipment (UE), mobile stations (MS), mobile terminals (MT), etc. Terminals may be automobiles with communication functions, smart cars, mobile phones, wearable devices, tablet computers (Pad), computers with wireless transceiver functions, virtual reality (VR) terminals, augmented reality (AR) terminals, wireless terminals in industrial control, wireless terminals in self-driving, wireless terminals in remote medical surgery, wireless terminals in smart grids, wireless terminals in transportation safety, wireless terminals in smart cities, wireless terminals in smart homes, etc. The embodiments of the present disclosure do not limit the specific technologies and specific device forms adopted by the terminals.

In sidelink communication, there are four sidelink transmission modes. Sidelink transmission mode 1 and sidelink transmission mode 2 are used for device-to-device (D2D) communication. Sidelink transmission mode 3 and sidelink transmission mode 4 are used for V2X communication. When sidelink transmission mode 3 is adopted, resource allocation is scheduled by network device 101. Specifically, network device 101 may send resource allocation information to terminal 102, and then terminal 102 allocates resources to another terminal, so that the another terminal may send information to the network device 101 through the allocated resources. In V2X communication, the terminal with better signal or higher reliability may be used as terminal 102. The first terminal mentioned in the embodiments of the present disclosure may refer to the terminal 102, and the second terminal may refer to the another terminal.

It is understandable that the communication system described in the embodiments of the present disclosure is for a clearer illustration of the technical solutions of the embodiments of the present disclosure and does not constitute a limitation to the technical solutions provided in the embodiments of the present disclosure. It is known to those skilled in the art that with the evolution of the system architecture and the emergence of new business scenarios, the technical solutions provided in the embodiments of the present disclosure are also applicable to similar technical problems.

It should be noted that the precoding matrix determination method for uplink MIMO transmission provided in any embodiment of the present disclosure may be executed independently, or be executed together with the possible implementation methods in other embodiments, and may also be executed together with any technical solution in related technologies.

The following provides a detailed introduction to the precoding matrix determination method and apparatus for uplink MIMO transmission provided by the present disclosure in combination with the accompanying drawings.

Please refer to FIG. 2. FIG. 2 is a flow diagram showing a precoding matrix determination method for uplink MIMO transmission provided by an embodiment of the present disclosure. This precoding matrix determination method for uplink MIMO transmission is executed by a terminal. As shown in FIG. 2, this method may include but is not limited to the following steps:

S201, a channel status information reference signal (CSI-RS) of 8-antenna ports sent by a network device is received.

In the embodiments of the present disclosure, the network device may send the CSI-RS of 8-antenna ports to the terminal. Correspondingly, the terminal may perform downlink channel estimation based on the CSI-RS to determine the state of the downlink channel.

S202, a target codeword coefficient adaptive to the current channel state is determined according to the CSI-RS, and the target codeword coefficient is sent to the network device.

After receiving the CSI-RS, the terminal may perform downlink channel estimation based on the CSI-RS, and may determine the target codeword coefficient adaptive to the current channel state according to the estimation result of the downlink channel. Optionally, the terminal may determine the target codeword adapted to the current channel state from the 8-antenna ports codebook for uplink transmission according to the estimation result of the downlink channel.

In the embodiments of the present disclosure, the codewords in the 8-antenna ports codebook for uplink transmission are formed by splicing the codeword coefficients from the low-dimensional 4-antenna ports codebook or 2-antennas port codebook. After determining the target codeword, the codeword coefficient associated with the target codeword may be further determined as the target codeword coefficient.

In the present disclosure, the determination ways of the 4-antenna ports codebook and the 2-antenna ports codebook are not limited and may be determined according to the actual situation.

Optionally, the 4-antenna ports codebook may be the uplink precoding codebook of the 4-antenna ports for uplink MIMO transmission as stipulated in the 3GPP communication protocol: the 2-antenna ports codebook may be the uplink precoding codebook of the 2-antenna ports for uplink MIMO transmission as stipulated in the 3GPP communication protocol. Optionally, the 4-antenna ports codebook may be the downlink precoding codebook of the 4-antenna ports for downlink MIMO transmission as stipulated in the 3GPP communication protocol: the 2-antenna ports codebook may be the downlink precoding codebook of the 2-antenna ports for downlink MIMO transmission as stipulated in the 3GPP communication protocol.

Optionally, the 4-antenna ports codebook may be a codebook of 4-antenna ports determined based on a 4-dimensional orthogonal codebook, such as the Kerdock codebook. Optionally, the 2-antenna ports codebook may be a codebook of 2-antenna ports determined based on a 2-dimensional orthogonal codebook, such as the Kerdock codebook. It should be noted that the Kerdock codebook is an orthogonal codebook in the design of communication systems and may be used to construct mutually unbiased bases sequences. The Kerdock codebook has orthogonality, that is, any two columns of vectors in each Kerdock codeword are orthogonal to each other.

Further, the terminal may indicate the target codeword coefficient to the network device. Optionally, the terminal sends the codeword coefficient index to the network device and indicates the target codeword coefficient to the network device through this codeword coefficient index.

S203, an SRS of 8-antenna ports is sent to the network device.

In the uplink MIMO codebook-based PUSCH transmission, the terminal needs to obtain the optimal precoding matrix. In the embodiment of the present disclosure, the terminal may send the SRS of 8-antenna ports to the network device based on the codebook.

S203, the indication information sent by the network device is received, where the indication information indicates the target precoding matrix required for uplink transmission.

In the embodiment of the present disclosure, the target precoding matrix is determined according to the target codeword coefficient and the SRS.

After the terminal sends the SRS to the network device, the network device may determine the optimal precoding matrix from the 8-antenna ports codebook according to the SRS sent by the terminal and the target codeword coefficient as the target precoding matrix. And the network device indicates the target precoding matrix required for uplink transmission to the terminal through the indication information.

Optionally, the terminal may directly determine the target precoding matrix required for uplink transmission according to the indication information. In some implementations, the indication information is the transmit precoding matrix indicator (TPMI) sent by the network device. The terminal may receive the TPMI sent by the network device and directly determine the target precoding matrix required for uplink transmission through this TPMI.

Optionally, the terminal may implicitly determine the target precoding matrix required for uplink transmission according to the indication information. In some implementations, the indication information is the beam indication, then the terminal may receive the beam indication determined based on the target precoding matrix sent by the network device and determine the target precoding matrix through this beam indication. The terminal may determine the target precoding matrix according to the beam indication and the target codeword coefficient.

S205, data are pre-coded according to the target precoding matrix, and sent to the network device.

After obtaining the target precoding matrix, the data to be transmitted may be pre-coded based on the target precoding matrix, and the data after precoding are sent to the network device. The data to be transmitted may be PUSCH, that is, the terminal pre-codes PUSCH through the target precoding matrix and sends the PUSCH after precoding to the network device.

In the embodiments of the present disclosure, the CSI-RS of 8-antenna ports sent by the network device is received, the target codeword coefficient adaptive to the current channel state is determined according to the CSI-RS, and the target codeword coefficient is sent to the network device, the SRS of 8-antenna ports is sent to the network device, the indication information indicating the target precoding matrix required for uplink transmission sent by the network device is received, where the target precoding matrix is determined according to the target codeword coefficient and the SRS, further the data are pre-coded according to the target precoding matrix, and sent to the network device. In the embodiments of the present disclosure, by determining the target codeword coefficient through the downlink channel feedback, and determining the target precoding matrix that can support the uplink MIMO 8-antenna ports transmission by the codebook coefficients, the demand for enhancing the uplink MIMO transmission may be met.

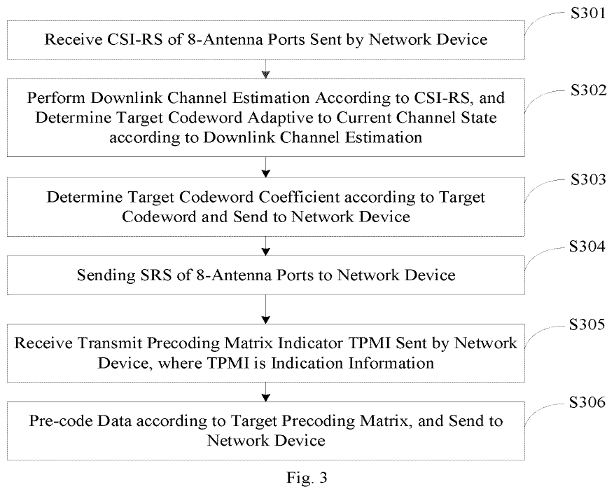

Please refer to FIG. 3. FIG. 3 is a flow diagram showing a precoding matrix determination method for uplink MIMO transmission provided by an embodiment of the present disclosure. This precoding matrix determination method for uplink MIMO transmission is executed by a terminal. As shown in FIG. 3, this method may include but is not limited to the following steps:

S301, the CSI-RS of 8-antenna ports sent by the network device is received.

For the specific introduction of step S301, please refer to the records of the relevant content in the above-mentioned embodiments. It will not be elaborated here.

S302, the downlink channel estimation is performed according to the CSI-RS, and the target codeword is determined adaptive to the current channel state according to the downlink channel estimation.

Optionally, the terminal may perform downlink channel estimation based on CSI-RS to determine the estimation status of the downlink channel. Further, the terminal may determine the optimal codeword that is adapted to the current channel state from the 8-antenna ports codebook for downlink transmission based on the estimation result of the downlink channel as the target codeword.

S303, the target codeword coefficient is determined according to the target codeword and sent to the network device.

In the embodiments of the present disclosure, the 8-antenna ports codebook for uplink transmission may be formed by splicing the codeword coefficients from the low-dimensional 4-antenna ports codewords. After determining the target codeword, the codeword coefficient associated with the target codeword may be further determined, where the codeword coefficient associated with the target codeword is namely as the target codeword coefficient.

It should be noted that in the case of a single antenna panel, the codeword coefficient includes the common phase coefficient. In the case of plurality of antenna panels, the codeword coefficient includes the common phase coefficient and the compensation factor of the antenna panel. In cases of different antenna structures, the corresponding codeword coefficients are different.

For example, when the phase angle interval between antennas is 90°, the common phase coefficient may be one of +1, −1, +j, −j, that is φ=+1, −1, +j, −j. Another example is that when the phase angle interval between antennas is 45°, the common phase coefficient may be one of +1,

$$\frac{\sqrt{2}}{2} ( 1 + j ) , + j , \frac{\sqrt{2}}{2} ( - 1 + j ) , - 1 , \frac{\sqrt{2}}{2} ( - 1 - j ) , - j and \frac{\sqrt{2}}{2} ( 1 - j ) .$$

The number of codeword coefficients included in the candidate codeword coefficient set corresponding to the phase angle intervals between different antennas is different. In the embodiments of the present disclosure, the correspondence relationship between the codeword coefficients and the codeword coefficient indices is pre-constructed. The terminal may report the target codeword coefficient to the network device based on this correspondence relationship. The network device may query this correspondence relationship according to the received codeword coefficient index to determine the target codeword coefficient reported by the terminal.

For example, in the case that the phase angle interval between antennas is 90°, the correspondence relationship between the common phase coefficient and the codeword coefficient index is shown in Table 1:

TABLE 1

| codeword coefficient index | 0 | 1 | 2 | 3 |
|---|---|---|---|---|
| phase angle interval | 0° | 90° | 180° | 270° |
| common phase coefficient | +1 | +j | −1 | −j |

For another example, in the case that the phase angle interval between antennas is 45°, the correspondence relationship between the common phase coefficient and the codeword coefficient index is shown in Table 2:

TABLE 2

| codeword | 0 | 1 | 2 | 3 | 4 | 5 | 6 | 7 |
|---|---|---|---|---|---|---|---|---|
| coefficient | | | | | | | | |
| index | | | | | | | | |
| phase angle | 0° | 45º | 90º | 135° | 180° | 225° | 270° | 315° |
| interval | | | | | | | | |
| common phase coefficient | +1 | $\frac{\sqrt{2}}{2} ( 1 + j )$ | +j | $\frac{\sqrt{2}}{2} ( - 1 + j )$ | −1 | $\frac{\sqrt{2}}{2} ( - 1 - j )$ | −j | $\frac{\sqrt{2}}{2} ( 1 - j )$ |

It is understandable that each element in Table 1 and Table 2 exists independently. These elements are listed in the same table as examples, but it does not mean that all the elements in the table must exist simultaneously as shown in the table. The value of each element does not depend on the value of any other element in Table 1 and Table 2. Therefore, those skilled in the art may understand that the value of each element in Table 1 and Table 2 is an independent embodiment.

In the embodiments of the present disclosure, the terminal may determine the first bit number occupied by the codeword coefficient index according to the phase angle interval between antennas in the antenna structure information, and occupy the first bit number to send the codeword coefficient index to the network device.

As shown in Table 1, when the phase angle interval between antennas is 90°, the candidate codeword coefficient set includes 4 codeword coefficients, and the terminal may determine that the first bit number occupied by the codeword coefficient index is 2 bits. That is to say, the terminal needs to occupy 2 bits to report the codeword coefficient index to the network device. As shown in Table 2, when the phase angle interval between antennas is 45°, the candidate codeword coefficient set includes 8 codeword coefficients, and the terminal may determine that the first bit number occupied by the codeword coefficient index is 3 bits. That is to say, the terminal needs to occupy 3 bits to report the codeword coefficient index to the network device.

S304, the SRS of 8-antenna ports is sent to the network device.

For the specific introduction of step S304, please refer to the records of the relevant content in the above-mentioned embodiments. It will not be elaborated here.

S305, the transmit precoding matrix indicator (TPMI) sent by the network device is sent, where the TPMI is the indication information.

In the embodiments of the present disclosure, the indication information is used for indicating the target precoding matrix required for uplink transmission, where the target precoding is determined by the network device according to the target codeword coefficient and the SRS.

Optionally, after the terminal transmits the SRS of 8-antenna ports to the network device, the network device determines the uplink transmission codebook associated with the target codeword coefficient, and determines the optimal precoding matrix from the associated uplink transmission codebook according to the estimation result of the uplink channel estimation performed based on the SRS. The network device may send the TPMI of the optimal precoding matrix to the terminal.

The terminal may determine the target precoding matrix from the 8-antenna ports codebook based on the received TPMI. The terminal may determine the uplink transmission codebook associated with the target codeword coefficient according to the target codeword coefficient, and determine the codeword corresponding to the TPMI from the associated uplink transmission codebook based on the received TPMI, and take it as the target precoding matrix.

S306, data are pre-coded according to the target precoding matrix, and sent to the network device.

For the specific introduction of step S306, please refer to the records of the relevant content in the above-mentioned embodiments. It will not be elaborated here.

In the embodiments of the present disclosure, the CSI-RS of 8-antenna ports sent by the network device is received, the target codeword coefficient adapted to the current channel state is determined according to the CSI-RS, and the target codeword coefficient is sent to the network device. The SRS of 8-antenna ports is sent to the network device, the TPMI sent by the network device is received. Further, the target precoding matrix is determined according to the TPMI and the target codebook coefficient, and the data is pre-coded based on the target precoding matrix and sent to the network device. In the embodiments of the present disclosure, the target codeword coefficient is determined through the downlink channel feedback. On the basis of the existing TPMI mechanism, combined with the determination of the target precoding matrix that can support the uplink MIMO 8-antenna ports transmission through the codebook coefficient, the requirement for uplink MIMO transmission enhancement may be met.

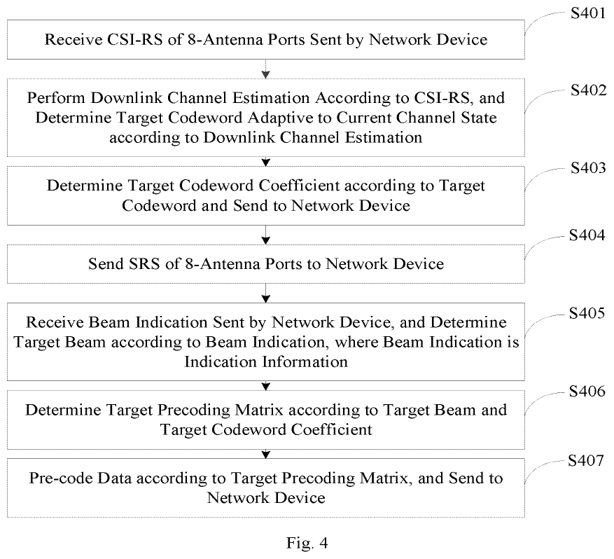

Please refer to FIG. 4. FIG. 4 is a flow diagram showing a precoding matrix determination method for uplink MIMO transmission provided by an embodiment of the present disclosure. This precoding matrix determination method for uplink MIMO transmission is executed by a terminal. As shown in FIG. 4, this method may include but is not limited to the following steps:

S401, the CSI-RS of 8-antenna ports sent by the network device is received.

S402, the downlink channel estimation is performed according to the CSI-RS, and the target codeword is determined adaptive to the current channel state according to the downlink channel estimation.

S403, the target codeword coefficient is determined according to the target codeword and sent to the network device.

S404, the SRS of 8-antenna ports is sent to the network device.

For the specific introduction of steps S401 to S404, please refer to the records of the relevant content in the above-mentioned embodiments. It will not be elaborated here.

S405, the beam indication sent by the network device is received, and the target beam is determined according to the beam indication, where the beam indication is the indication information.

Optionally, after the terminal transmits the SRS of 8-antenna ports to the network device, the network device determines the uplink transmission codebook associated with the target codeword coefficient, and determines the optimal codewords from the associated uplink transmission codebook according to the estimation result of the uplink channel estimation performed based on the SRS. After determining the optimal precoding matrix from the associated uplink transmission codebook, the network device may further determine the target beam associated with the optimal precoding matrix.

Further, the network device may determine the beam indication of the target beam as the indication information and send the indication information to the terminal. Correspondingly, the terminal may receive the indication information sent by the network device, that is, receive the beam indication.

Optionally, the second bit number occupied by the beam indication may be determined based on the attribute information of the target beam. The attribute information of the target beam may include: the values of N₁, N₂, O₁, O₂, and the values of i_{1,1}, i_{1,2}, i_{1,3}, i₂ coefficients supported in the uplink codebook, etc. Among them, N₁ and N₂ are the number of antenna ports in the first dimension and the number of antenna ports in the second dimension respectively, and O₁ and O₂ are the first-dimensional oversampling value and the second-dimensional oversampling value respectively. The network device may determine the second bit number based on the above attribute information and send the beam indication to the terminal by occupying the second bit number.

After receiving the beam indication, the terminal may determine the target beam indicated by the received beam indication according to the mapping relationship between the beam indication and the beam.

S406, the target precoding matrix is determined according to the target beam and the target codeword coefficient.

After determining the target beam and the target codeword coefficient, the 8-antenna ports codeword may be determined according to the generation formula of the 8-antenna ports codeword as the target precoding matrix. For an illustration of an example, there is a codebook based on the downlink Type I for 8-antenna ports codebook to be determined, as shown in Table 3:

TABLE 3
codebookMode = 1

| i_{1,1} | i_{1,2} | i₂ | |
|---|---|---|---|
| 0,1, ... , N₁O₁ − 1 | 0, ... , N₂O₂ − 1 | 0,1 | Wᵢ_{_{1,1}}ᵢ_{_{1,1}}₊ₖ_{₁}_{,i}_{_{1,2}}_{,i}_{_{1,2}}₊ₖ_{₂}_{,i}_{₂}⁽²⁾ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] .$ and the mapping from i_{1,3} to k₁ and k₂ is given in Table 5.2.2.2.1-3.

Among them, v represents the selected target beam and it is a characteristic of broadband: φₙ represents the common phase coefficient and it is a characteristic of narrowband.

It is understandable that each element in Table 3 exists independently. These elements are listed in the same table as examples, but it does not mean that all the elements in the table must exist simultaneously as shown in the table. The value of each element does not depend on the value of any other element in Table 3. Therefore, those skilled in the art may understand that the value of each element in Table 3 is an independent embodiment.

S407, data are pre-coded according to the target precoding matrix, and sent to the network device.

For the specific introduction of step S407, please refer to the records of the relevant content in the above-mentioned embodiments. It will not be elaborated here.

In the embodiments of the present disclosure, the network device indicates the target beam to the terminal. The terminal may determine the target precoding matrix that can support the transmission of 8-antenna ports for the uplink MIMO system through the codeword coefficient and the target beam, which may meet the requirements of uplink MIMO transmission enhancement.

It should be noted that the target codeword coefficient may include a common phase coefficient and a compensation factor between antennas. Among them, the common phase coefficient and the compensation factor may be determined in the same way, and the common phase coefficient and the compensation factor may also be determined in different ways. In some implementations, the common phase coefficient and the compensation factor are both determined based on the CSI-RS. In some other implementations, one of the common phase coefficient and the compensation factor is determined based on the CSI-RS provided in the above embodiments, and the other is determined in other ways. For example, the common phase coefficient may be determined in the way of being based on the CSI-RS, while the compensation factor may be determined in other ways. Another example is that the compensation factor may be determined in the way of being based on the CSI-RS, while the common phase coefficient may be determined in other ways.

In some implementations, after receiving the SRS of 8-antenna ports, the network device may perform downlink channel estimation based on the SRS. Based on the estimation result of the downlink channel estimation, the second item in the target codeword coefficient adapted to the current channel state is determined. For example, the compensation factor or the common phase coefficient may be determined based on the SRS.

In other implementations, the terminal may determine the second item in the target codeword coefficient based on the antenna structure information. For example, based on the phase angle interval between antennas indicated by the antenna structure information, the second item of the target codeword coefficient may be determined. For example, the compensation factor or the common phase coefficient may be determined based on the phase angle interval between antennas. As shown in Table 1 or 2, different phase angle intervals between antennas may correspond to different common phase coefficients.

It may be understood that the common phase coefficient and the compensation factor may be determined in the same way, and the common phase coefficient and the compensation factor may also be determined in different ways, which is applicable to each embodiment of the present disclosure.

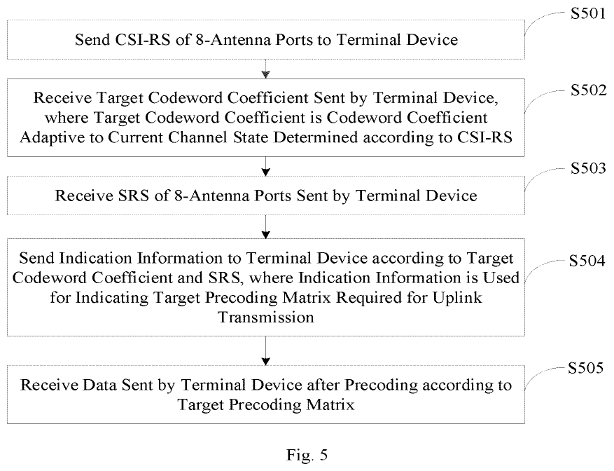

Please refer to FIG. 5. FIG. 5 is a flow diagram showing a precoding matrix determination method for uplink MIMO transmission provided by an embodiment of the present disclosure. This precoding matrix determination method for uplink MIMO transmission is executed by a terminal. As shown in FIG. 5, this method may include but is not limited to the following steps:

S501, an CSI-RS of 8-antenna ports is sent to a terminal.

In the embodiments of the present disclosure, the network device may send the CSI-RS of 8-antenna ports to the terminal, so that the terminal may perform downlink channel estimation based on the CSI-RS to determine the state of the downlink channel.

S502, a target codeword coefficient sent by the terminal is received, where the target codeword is a codeword coefficient adaptive to the current channel state determined according to the CSI-RS.

After receiving the CSI-RS, the terminal may perform downlink channel estimation based on the CSI-RS, and may determine the target codeword coefficient adaptive to the current channel state according to the estimation result of the downlink channel. Optionally, the terminal may determine the target codeword adapted to the current channel state from the 8-antenna ports codebook for uplink transmission according to the estimation result of the downlink channel.

In the embodiments of the present disclosure, the codewords in the 8-antenna ports codebook for uplink transmission are formed by splicing the codeword coefficients from the low-dimensional 4-antenna ports codebook or 2-antennas port codebook. After determining the target codeword, the codeword coefficient associated with the target codeword may be further determined as the target codeword coefficient.

Further, the network device may receive the target codeword coefficient indicated by the terminal. Optionally, the network device may receive the codeword coefficient index sent by the terminal and determine the target codeword coefficient determined through this codeword coefficient index by the terminal.

S503, an SRS of 8-antenna ports sent by the terminal is received.

In the uplink MIMO codebook-based PUSCH transmission, the terminal needs to obtain the optimal precoding matrix. In the embodiment of the present disclosure, the terminal may send the SRS of 8-antenna ports to the network device based on the codebook.

S504, indication information is sent to the terminal according to the target codeword coefficient and the SRS, where the indication information is used for indicating a target precoding matrix required for uplink transmission.

In the embodiment of the present disclosure, the target precoding matrix is determined according to the target codeword coefficient and the SRS.

After receiving the SRS sent by the terminal, the network device may determine the optimal precoding matrix from the 8-antenna ports codebook according to the SRS sent by the terminal and the target codeword coefficient as the target precoding matrix. And the network device indicates the target precoding matrix required for uplink transmission to the terminal through the indication information.

Optionally, the network device sends indication information directly indicating the target precoding matrix to the terminal. In some implementations, the indication information is the TPMI sent by the network device, and the terminal may receive the TPMI sent by the network device and directly determine the target precoding matrix required for uplink transmission through this TPMI.

Optionally, the network device may send implicit indication information to the terminal, and the terminal may determine the target precoding matrix required for uplink transmission based on this implicit indication information. In some implementations, if the indication information is beam indication, the terminal may receive the beam indication determined according to the target precoding matrix sent by the network device and determine the target precoding matrix through this beam indication. The terminal may determine the target precoding matrix based on the beam indication and the target codeword coefficient.

Optionally, the network device may also determine information such as SRS resources, the number of transmission layers, and the modulation and coding scheme (MCS) corresponding to uplink transmission based on uplink channel estimation.

S505, data sent by the terminal after precoding according to the target precoding matrix are received.

After obtaining the target precoding matrix, the terminal may pre-code the data to be transmitted based on the target precoding matrix, and send the data after precoding to the network device. Correspondingly, the network device may receive the data after precoding. Optionally, the data to be transmitted may be PUSCH, that is, the terminal pre-codes PUSCH through the target precoding matrix and sends the PUSCH after precoding to the network device.

In the embodiments of the present disclosure, the CSI-RS of 8-antenna ports is sent to the terminal, the target codeword coefficient determined by the terminal based on the CSI-RS is sent, the SRS of 8-antenna ports sent by the terminal is received, the indication information for indicating the target precoding matrix required for uplink transmission is sent to the terminal according to the target codeword coefficient and the SRS, and further, the data sent by the terminal after precoding based on the target precoding matrix are received. In the embodiments of the present disclosure, by determining the target codeword coefficient through the downlink channel feedback, and determining the target precoding matrix that can support the uplink MIMO 8-antenna ports transmission by the codebook coefficients, the demand for enhancing the uplink MIMO transmission may be met.

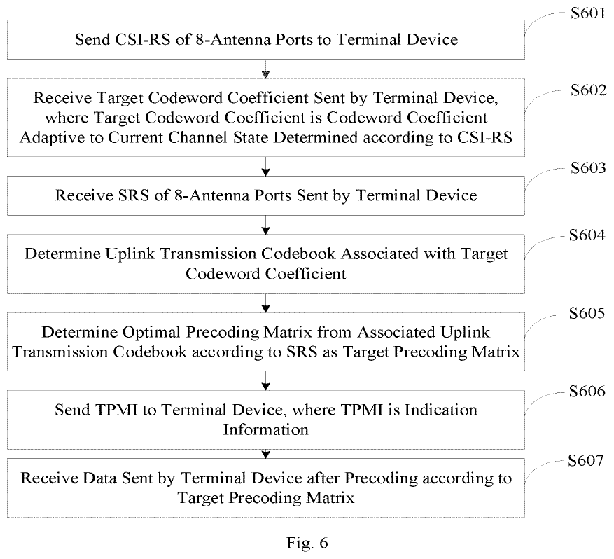

Please refer to FIG. 6. FIG. 6 is a flow diagram showing a precoding matrix determination method for uplink MIMO transmission provided by an embodiment of the present disclosure. This precoding matrix determination method for uplink MIMO transmission is executed by a network device. As shown in FIG. 6, this method may include but is not limited to the following steps:

S601, the CSI-RS of 8-antenna ports is sent to a terminal.

For the specific introduction of step S601, please refer to the records of the relevant content in the above-mentioned embodiments. It will not be elaborated here.

S602, a target codeword coefficient sent by the terminal is received, where the target codeword is a codeword coefficient adaptive to the current channel state determined according to the CSI-RS.

In the embodiments of the present disclosure, the 8-antenna ports codebook for uplink transmission may be formed by splicing the codeword coefficients from the 4-antenna ports codewords. After determining the target codeword, the terminal may further determine the codeword coefficient associated with the target codeword, where the codeword coefficient associated with the target codeword is namely as the target codeword coefficient. After determining the target codeword coefficient, the network device may receive the target codeword coefficient reported by the terminal.

The number of codeword coefficients included in the candidate codeword coefficient set corresponding to the phase angle intervals between different antennas is different. In the embodiments of the present disclosure, the correspondence relationship between the codeword coefficients and the codeword coefficient indices is pre-constructed. The terminal may report the target codeword coefficient to the network device based on this correspondence relationship. The network device may query this correspondence relationship according to the received codeword coefficient index to determine the target codeword coefficient reported by the terminal.

In the embodiments of the present disclosure, the terminal may determine the first bit number required for the codeword coefficient index to occupy according to the phase angle interval between antennas in the antenna structure information, and occupy the first bit number to send the codeword coefficient index to the network device. Correspondingly, the network device receives the codeword coefficient index reported through the first bit number by the terminal. S603, an SRS of 8-antenna ports sent by the terminal is received.

For the specific introduction of step S603, please refer to the records of the relevant content in the above-mentioned embodiments. It will not be elaborated here.

S604, an uplink transmission codebook associated with the target codeword coefficient is determined.

In the embodiment of the present disclosure, different codeword coefficients may correspond to different uplink transmission codebooks. After the target codeword coefficient is received, the uplink transmission codebook associated with the target codeword coefficient may be determined from a plurality of uplink transmission codebooks based on the target codeword coefficient.

S605, an optimal precoding matrix is determined from the associated uplink transmission codebook as the target precoding matrix.

S606, a TPMI is sent to the terminal, where the TPMI is the indication information.

Further, after receiving the SRS sent by the terminal, the network device may perform uplink channel estimation based on the SRS sent by the terminal. The network device determines the optimal precoding matrix from the associated uplink transmission codebook based on the estimation result, and takes this optimal precoding matrix as the target precoding matrix. The network device may send the TPMI of this target precoding matrix to the terminal.

Further, the terminal may determine the target precoding matrix from the 8-antenna ports codebook based on the received TPMI. The terminal may determine the uplink transmission codebook associated with the target codeword coefficient based on the target codeword coefficient, and determine the codeword corresponding to the TPMI from the associated uplink transmission codebook based on the received TPMI, and take it as the target precoding matrix.

S607, data sent by the terminal after precoding according to the target precoding matrix are received.

For the specific introduction of step S607, please refer to the records of the relevant content in the above-mentioned embodiments. It will not be elaborated here.

In the embodiments of the present disclosure, the target codeword coefficient is determined through the downlink channel feedback. On the basis of the existing TPMI mechanism, combined with the determination of the target precoding matrix that can support the uplink MIMO 8-antenna ports transmission through the codebook coefficient, the requirement for uplink MIMO transmission enhancement may be met.

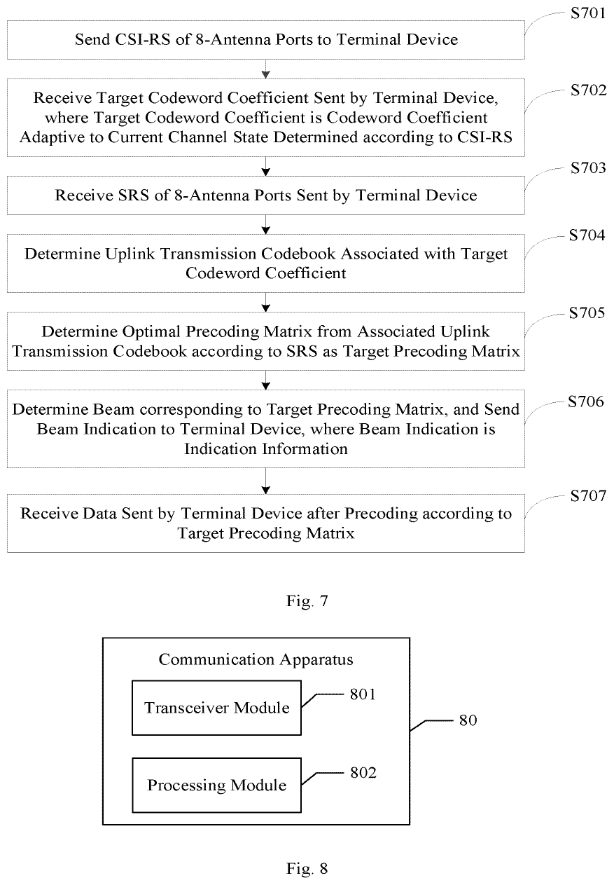

Please refer to FIG. 7. FIG. 7 is a flow diagram showing a precoding matrix determination method for uplink MIMO transmission provided by an embodiment of the present disclosure. This precoding matrix determination method for uplink MIMO transmission is executed by a network device. As shown in FIG. 7, this method may include but is not limited to the following steps:

S701, the CSI-RS of 8-antenna ports is sent to a terminal.

S702, the target codeword coefficient sent by the terminal is received, where the target codeword is a codeword coefficient adaptive to the current channel state determined according to the CSI-RS.

S703, the SRS of 8-antenna ports sent by the terminal is received.

S704, the uplink transmission codebook associated with the target codeword coefficient is determined.

S705, the optimal precoding matrix is determined from the associated uplink transmission codebook as the target precoding matrix.

For the specific introduction of steps S701 to S705, please refer to the records of the relevant content in the above-mentioned embodiments. It will not be elaborated here.

S706, a beam corresponding to the target precoding matrix is determined, and beam indication is sent to the terminal, where the beam indication is the indication information,

In the embodiments of the present disclosure, the target precoding matrix is determined according to the beam indication and the target codeword coefficient.

Optionally, after the terminal transmits the SRS of 8-antenna ports to the network device, the network device determines the uplink transmission codebook associated with the target codeword coefficient, and determines the optimal codewords from the associated uplink transmission codebook according to the estimation result of the uplink channel estimation performed based on the SRS. After determining the optimal precoding matrix from the associated uplink transmission codebook, the network device may further determine the target beam associated with the optimal precoding matrix.

Further, the network device may determine the beam indication of the target beam as the indication information and send the indication information to the terminal. Correspondingly, the terminal may receive the indication information sent by the network device, that is, receive the beam indication.

Optionally, the second bit number occupied by the beam indication may be determined based on the attribute information of the target beam. The attribute information of the target beam may include: the values of N₁, N₂, O₁, O₂, and the values of i_{1,1}, i_{1,2}, i_{1,3}, i₂ coefficients supported in the uplink codebook, etc. Among them, N₁ and N₂ are the number of antenna ports in the first dimension and the number of antenna ports in the second dimension respectively, and O₁ and O₂ are the first-dimensional oversampling value and the second-dimensional oversampling value respectively. The network device may determine the second bit number based on the above attribute information and send the beam indication to the terminal by occupying the second bit number.

After receiving the beam indication, the terminal may determine the target beam indicated by the received beam indication according to the mapping relationship between the beam indication and the beam.

S707, data sent by the terminal after precoding according to the target precoding matrix are received.

For the specific introduction of step S707, please refer to the records of the relevant content in the above-mentioned embodiments. It will not be elaborated here.

In the embodiments of the present disclosure, the network device indicates the target beam to the terminal. The terminal may determine the target precoding matrix that can support the transmission of 8-antenna ports for the uplink MIMO system through the codeword coefficient and the target beam, which may meet the requirements of uplink MIMO transmission enhancement.

It should be noted that the target codeword coefficient may include a common phase coefficient and a compensation factor between antennas. Among them, the common phase coefficient and the compensation factor may be determined in the same way, and the common phase coefficient and the compensation factor may also be determined in different ways. In some implementations, the common phase coefficient and the compensation factor are both determined based on the CSI-RS. In some other implementations, one of the common phase coefficient and the compensation factor is determined based on the CSI-RS provided in the above embodiments, and the other is determined in other ways. For example, the common phase coefficient may be determined in the way of being based on the CSI-RS, while the compensation factor may be determined in other ways. Another example is that the compensation factor may be determined in the way of being based on the CSI-RS, while the common phase coefficient may be determined in other ways.

In some implementations, after receiving the SRS of 8-antenna ports, the network device may perform downlink channel estimation based on the SRS. Based on the estimation result of the downlink channel estimation, the second item in the target codeword coefficient adapted to the current channel state is determined. For example, the compensation factor or the common phase coefficient may be determined based on the SRS.

In other implementations, the terminal may determine the second item in the target codeword coefficient based on the antenna structure information. For example, based on the phase angle interval between antennas indicated by the antenna structure information, the second item of the target codeword coefficient may be determined. For example, the compensation factor or the common phase coefficient may be determined based on the phase angle interval between antennas. As shown in Table 1 or 2, different phase angle intervals between antennas may correspond to different common phase coefficients.

It may be understood that the common phase coefficient and the compensation factor may be determined in the same way, and the common phase coefficient and the compensation factor may also be determined in different ways, which is applicable to each embodiment of the present disclosure.

In the embodiments provided in the above-mentioned present disclosure, the methods provided in the embodiments of the present disclosure are introduced respectively from the perspectives of network devices and terminals. To implement the various functions in the methods provided in the above-mentioned embodiments of the present disclosure, network devices and terminals may include hardware structures, software modules, and implement the above-mentioned various functions in the form of hardware structures, software modules, or a combination of hardware structures and software modules. A certain function among the above-mentioned various functions may be executed in the form of a hardware structure, a software module, or a combination of a hardware structure and a software module.

Please refer to FIG. 8. FIG. 8 is a schematic diagram showing the structure of a communication apparatus 80 provided by an embodiment of the present disclosure. The communication apparatus 80 shown in FIG. 8 may include a transceiver module 801 and a processing module 802. The transceiver module 801 may include a transmission module and/or a reception module. The transmission module is used to implement the transmission function, and the reception module is used to implement the reception function. The transceiver module 801 may implement the transmission function and/or the reception function.

The communication apparatus 80 may be a terminal, or an apparatus in the terminal, or an apparatus that can be used in matching with the terminal. Alternatively, the communication apparatus 80 may be a network device, or an apparatus in the network device, or an apparatus that can be used in matching with the network device.

Taking that the communication apparatus 80 is a terminal as an example, the communication apparatus 80 includes:
transceiver module 801, configured to receive a CSI-RS of 8-antenna ports sent by a network device: determine a target codeword coefficient adaptive to the current channel state according to the CSI-RS, and send the target codeword coefficient to the network device: send an SRS of 8-antenna ports to the network device: receive indication information sent by the network device, where the indication information indicates a target precoding matrix required for uplink transmission, the target precoding being determined according to the target codeword coefficient and the SRS: pre-code data according to the target precoding matrix, and send to the network device.

Optionally, processing module 802 is configured to perform downlink channel estimation according to the CSI-RS: determine the target codeword coefficient, by determining a target codeword adaptive to the current channel state according to downlink channel estimation.

Optionally, transceiver module 801 is further configured to receive a transmit precoding matrix indicator (TPMI) sent by the network device, where the TPMI is the indication information.

Optionally, transceiver module 801 is further configured to receive beam indication sent by the network device, and determine a target beam according to the beam indication, where the beam indication is the indication information.

Optionally, processing module 802 is further configured to determine the target precoding matrix according to the target beam and the target codeword coefficient.

Optionally, transceiver module 801 is further configured to report a codeword coefficient index to the network device, the codeword coefficient index used for indicating the target codeword coefficient, the target codeword coefficient being at least one coefficient in a candidate codeword coefficient set.

Optionally, processing module 802 is configured to determine a first bit number occupied by the codeword coefficient index according to the antenna structure information.

Optionally, transceiver module 801 is further configured to report the codeword coefficient index to the network device, by occupying the first bit number.

Optionally, processing module 802 is further configured to determine the first bit number occupied by the codeword coefficient index according to a phase angle interval between antennas indicated by the antenna structure information.

Optionally, the target codeword coefficient includes a common phase coefficient and/or a compensation factor of antenna panel, where the common phase coefficient and the compensation factor of antenna panel are determined in a same way or in different ways.

Optionally, the common phase coefficient and the compensation factor are both determined according to the CSI-RS: or,
one of the common phase coefficient and the compensation factor is determined according to the CSI-RS, and the other is determined according to the SRS: or,
one of the common phase coefficient and the compensation factor is determined according to the CSI-RS, and the other is determined according to antenna structure information.

Taking that the communication apparatus 80 is a network device as an example, the communication apparatus 80 includes:
transceiver module 801, configured to send a CSI-RS of 8-antenna ports to a terminal; receive a target codeword coefficient sent by the terminal, where the target codeword coefficient is a codeword coefficient adaptive to a current channel state determined according to the CSI-RS; receive an SRS of 8-antenna ports sent by the terminal: send indication information to the terminal according to the target codeword coefficient and the SRS, where the indication information indicates a target precoding matrix required for uplink transmission: receive data sent by the terminal after precoding according to the target precoding matrix.

Optionally, processing module 802 is further configured to determine an uplink transmission codebook associated with the target codeword coefficient: determine an optimal precoding matrix from the associated uplink transmission codebook as the target precoding matrix.

Optionally, transceiver module 801 is further configured to send a TPMI to the terminal, where the TPMI is the indication information.

Optionally, transceiver module 801 is further configured to determine a beam corresponding to the target precoding matrix, and send beam indication to the terminal, where the beam indication is the indication information, and the target precoding matrix is determined by the terminal according to the beam indication and the target codeword coefficient.

Optionally, transceiver module 801 is further configured to receive a codeword coefficient index reported by the terminal, where a first bit number occupied by the codeword coefficient index is determined according to antenna structure information.

Optionally, processing module 802 is further configured to determine the target codeword coefficient according to the codeword coefficient index.

Optionally, the first bit number occupied by the codeword coefficient index is determined according to a phase angle interval between antennas indicated by the antenna structure information.

Optionally, the target codeword coefficient includes a common phase coefficient and/or a compensation factor of antenna panel. Processing module 802 is further configured to determine the common phase coefficient and the compensation factor of antenna panel in a same way or in different ways.

Optionally, processing module 802 is further configured to determine the common phase coefficient and the compensation factor both according to the CSI-RS: or,
determine one of the common phase coefficient and the compensation factor according to the CSI-RS, and determine the other according to the SRS: or,
determine one of the common phase coefficient and the compensation factor according to the CSI-RS, and determining the other according to antenna structure information.

In the embodiments of the present disclosure, the CSI-RS of 8-antenna ports sent by the network device is received, the target codeword coefficient adaptive to the current channel state is determined according to the CSI-RS, and the target codeword coefficient is sent to the network device, the SRS of 8-antenna ports is sent to the network device, the indication information used for indicating the target precoding matrix required for uplink transmission sent by the network device is received, where the target precoding matrix is determined according to the target codeword coefficient and the SRS, further the data are pre-coded according to the target precoding matrix, and sent to the network device. In the embodiments of the present disclosure, by determining the target codeword coefficient through the downlink channel feedback, and determining the target precoding matrix that can support the uplink MIMO 8-antenna ports transmission by the codebook coefficients, the demand for enhancing the uplink MIMO transmission may be met.

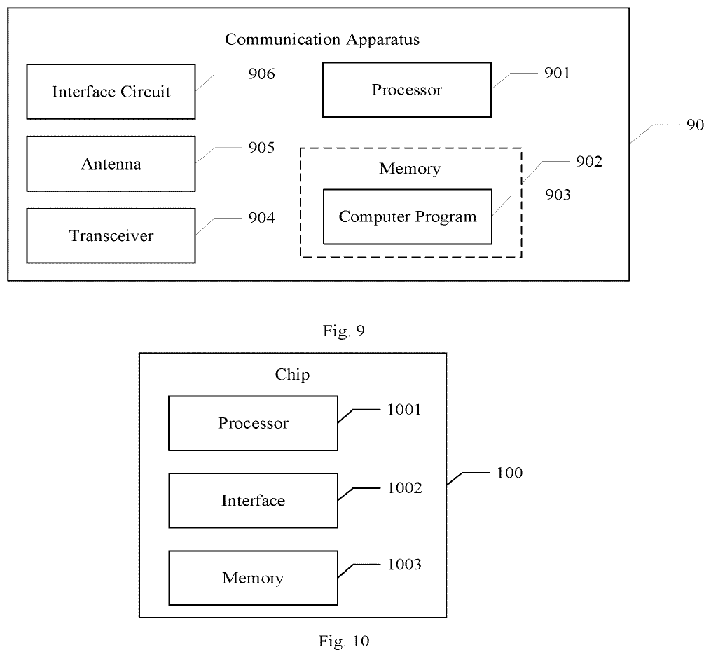

Please refer to FIG. 9. FIG. 9 is a schematic diagram showing the structure of another communication apparatus 90 provided by an embodiment of the present disclosure. Communication apparatus 90 may be a network device, a terminal, or a chip, chip system, or processor that supports a network device in implementing the aforementioned methods. It may also be a chip, chip system, or processor that supports a terminal in implementing the aforementioned methods. This apparatus may be used to implement the methods described in the method embodiments mentioned above; for specific details, refer to the descriptions in the aforementioned method embodiments.

Communication apparatus 90 may include one or more processors 901. Processor 901 may be a general-purpose processor or a special-purpose processor, such as a baseband processor or a central processing unit (CPU). The baseband processor may handle communication protocols and data, and the CPU may control the communication apparatus (such as a base station, baseband chip, terminal, terminal chip, DU, or CU, etc.), execute computer programs, and process data of computer programs.

Optionally, communication apparatus 90 may also include one or more memories 902, which may store computer programs 903. When processor 901 executes these computer programs 903, it enables the communication apparatus 90 to perform the methods described in the aforementioned method embodiments. Optionally, memory 902 may also store data. The communication apparatus 90 and memory 902 may be set up separately or integrated together.

Optionally, communication apparatus 90 may also include a transceiver 904 and an antenna 905. The transceiver 904 may also be referred to as a transceiver unit, transceiver, or transceiver circuit, used to achieve transmission and reception functions. Transceiver 904 can include a receiver and a transmitter, where the receiver may be called a receiver or receiving circuit, used to achieve receiving functions: the transmitter may be called a transmitter or transmitting circuit, used to achieve sending functions.

Optionally, the communication apparatus 90 may also include one or more interface circuits 906. The interface circuit 906 is used to receive code instructions and transmit them to the processor 901. The processor 901 runs the code instructions to enable the communication apparatus 90 to perform the methods described in the above method embodiments.

The communication apparatus 90 is a terminal for implementing the functions of the terminal in the aforementioned embodiments.

The communication apparatus 90 is a network device for implementing the functions of the network device in the aforementioned embodiments.

In one implementation, the processor 901 may include a transceiver for implementing receiving and transmitting functions. For example, the transceiver may be a transceiver circuit, an interface, or an interface circuit. The transceiver circuit, interface, or interface circuit for implementing receiving and transmitting functions may be separate or integrated. The aforementioned transceiver circuit, interface, or interface circuit may be used for reading and writing code/data, or for transmitting or transferring signals.

In one implementation, the processor 901 may store a computer program 903. The computer program 903 runs on the processor 901 and enables the communication apparatus 90 to perform the methods described in the above method embodiments. The computer program 903 may be solidified in the processor 901, in which case the processor 901 may be implemented by hardware.

In one implementation, the communication apparatus 90 may include circuits that may implement the functions of sending, receiving or communicating as described in the aforementioned method embodiments. The processors and transceivers described in the present disclosure may be implemented on integrated circuits (IC), analog ICs, radio frequency integrated circuits (RFICs), mixed-signal ICs, application-specific integrated circuits (ASICs), printed circuit boards (PCBs), electronic devices, etc. The processors and transceivers may also be fabricated using various IC process technologies, such as complementary metal oxide semiconductor (CMOS), negative channel metal oxide semiconductor (NMOS), positive channel metal oxide semiconductor (PMOS), bipolar junction transistors (BJT), bipolar CMOS (BiCMOS), silicon germanium (SiGe), gallium arsenide (GaAs), etc.

The communication apparatus described in the above embodiments may be a network device or the like, but the scope of the communication apparatus described in the present disclosure is not limited to this, and the structure of the communication apparatus is not restricted by FIG. 9. The communication apparatus may be an independent device or a part of a larger device. For example, the communication apparatus may be:
(1) an independent integrated circuit (IC), chip, chip system or subsystem;
(2) a collection of one or more ICs, optionally, the IC collection may also include storage components for storing data and computer programs;
(3) an application-specific integrated circuit (ASIC), such as a modem;
(4) a module that may be embedded in other devices;
(5) a receiver, terminal, smart terminal, cellular phone, wireless device, handheld device, mobile unit, vehicle-mounted device, network device, cloud device, artificial intelligence device, etc.;
(6) others, etc.

For the case where the communication apparatus may be a chip or a chip system, refer to the schematic diagram showing the structure of a chip in FIG. 10. The chip 100 shown in FIG. 10 includes a processor 1001 and an interface 1002. Among them, the number of processor 1001 may be one or more, and the number of interface 1002 may be more than one.

Chip 100 is used in terminals to implement the functions of the terminals as described in the aforementioned embodiments.

Interface 1002 is configured to receive a CSI-RS of 8-antenna ports sent by a network device: determine a target codeword coefficient adaptive to the current channel state according to the CSI-RS, and send the target codeword coefficient to the network device: send an SRS of 8-antenna ports to the network device: receive indication information sent by the network device, where the indication information indicates a target precoding matrix required for uplink transmission, the target precoding being determined according to the target codeword coefficient and the SRS: pre-code data according to the target precoding matrix, and send to the network device.

Optionally, processor 1001 is configured to perform downlink channel estimation according to the CSI-RS: determine the target codeword coefficient, by determining a target codeword adaptive to the current channel state according to downlink channel estimation.

Optionally, interface 1002 is further configured to receive a transmit precoding matrix indicator TPMI sent by the network device, where the TPMI is the indication information.

Optionally, interface 1002 is further configured to receive beam indication sent by the network device, and determine a target beam according to the beam indication, where the beam indication is the indication information.

Optionally, processor 1001 is further configured to determine the target precoding matrix according to the target beam and the target codeword coefficient.

Optionally, interface 1002 is further configured to report a codeword coefficient index to the network device, the codeword coefficient index used for indicating the target codeword coefficient, the target codeword coefficient being at least one coefficient in a candidate codeword coefficient set.

Optionally, processor 1001 is configured to determine a first bit number occupied by the codeword coefficient index according to the antenna structure information.

Optionally, interface 1002 is further configured to report the codeword coefficient index to the network device, by occupying the first bit number.

Optionally, processor 1001 is further configured to determine the first bit number occupied by the codeword coefficient index according to a phase angle interval between antennas indicated by the antenna structure information.

Optionally, the target codeword coefficient includes a common phase coefficient and/or a compensation factor of antenna panel, where the common phase coefficient and the compensation factor of antenna panel are determined in a same way or in different ways.

Optionally, the common phase coefficient and the compensation factor are both determined according to the CSI-RS: or,

one of the common phase coefficient and the compensation factor is determined according to the CSI-RS, and the other is determined according to the SRS: or,

one of the common phase coefficient and the compensation factor is determined according to the CSI-RS, and the other is determined according to antenna structure information.

Chip 100 is used in network devices to implement the functions of the network devices as described in the aforementioned embodiments.

Interface 1002 is configured to send a CSI-RS of 8-antenna ports to a terminal; receive a target codeword coefficient sent by the terminal, where the target codeword coefficient is a codeword coefficient adaptive to a current channel state determined according to the CSI-RS; receive an SRS of 8-antenna ports sent by the terminal: send indication information to the terminal according to the target codeword coefficient and the SRS, where the indication information indicates a target precoding matrix required for uplink transmission: receive data sent by the terminal after precoding according to the target precoding matrix.

Optionally, processor 1001 is further configured to determine an uplink transmission codebook associated with the target codeword coefficient: determine an optimal precoding matrix from the associated uplink transmission codebook as the target precoding matrix.

Optionally, interface 1002 is further configured to send a TPMI to the terminal, where the TPMI is the indication information.

Optionally, interface 1002 is further configured to determine a beam corresponding to the target precoding matrix, and send beam indication to the terminal, where the beam indication is the indication information, and the target precoding matrix is determined by the terminal according to the beam indication and the target codeword coefficient.

Optionally, interface 1002 is further configured to receive a codeword coefficient index reported by the terminal, where a first bit number occupied by the codeword coefficient index is determined according to antenna structure information.

Optionally, processor 1001 is further configured to determine the target codeword coefficient according to the codeword coefficient index.

Optionally, the first bit number occupied by the codeword coefficient index is determined according to a phase angle interval between antennas indicated by the antenna structure information.

Optionally, the target codeword coefficient includes a common phase coefficient and/or a compensation factor of antenna panel. Processor 1001 is further configured to determine the common phase coefficient and the compensation factor of antenna panel in a same way or in different ways.

Optionally, processor 1001 is further configured to determine the common phase coefficient and the compensation factor both according to the CSI-RS: or,
determine one of the common phase coefficient and the compensation factor according to the CSI-RS, and determine the other according to the SRS: or,
determine one of the common phase coefficient and the compensation factor according to the CSI-RS, and determining the other according to antenna structure information.

The chip 100 also includes a memory 1003, which is used to store necessary computer programs and data.

In the embodiments of the present disclosure, the CSI-RS of 8-antenna ports sent by the network device is received, the target codeword coefficient adaptive to the current channel state is determined according to the CSI-RS, and the target codeword coefficient is sent to the network device, the SRS of 8-antenna ports is sent to the network device, the indication information used for indicating the target precoding matrix required for uplink transmission sent by the network device is received, where the target precoding is determined according to the target codeword coefficient and the SRS, further the data are pre-coded according to the target precoding matrix, and sent to the network device. In the embodiments of the present disclosure, by determining the target codeword coefficient through the downlink channel feedback, and determining the target precoding matrix that can support the uplink MIMO 8-antenna ports transmission by the codebook coefficients, the demand for enhancing the uplink MIMO transmission may be met.

Those skilled in the art may also understand that the various illustrative logical blocks and steps listed in the embodiments of the present disclosure may be implemented through electronic hardware, computer software, or a combination of both. Whether such functions are implemented through hardware or software depends on the specific application and the design requirements of the entire system. Those skilled in the art may, for each specific application, implement the described functions using various methods, but such implementations should not be understood as beyond the scope of protection of the embodiments of the present disclosure.

In some embodiments of the present disclosure, the system includes the communication apparatus as the terminal and the communication apparatus as the network device in the embodiment of FIG. 10 mentioned above, or the system includes the communication apparatus as the terminal and the communication apparatus as the network device in the embodiment of FIG. 11 mentioned above.

The present disclosure also provides a readable storage medium on which instructions are stored. When the instructions are executed by a computer, the functions of any of the above-mentioned method embodiments are realized.

The present disclosure also provides a computer program product. When the computer program product is executed by a computer, the functions of any of the above-mentioned method embodiments are realized.

In the above embodiments, all or part of them may be implemented through software, hardware, firmware, or any combination thereof. When implemented through software, all or part of them may be implemented in the form of a computer program product. The computer program product includes one or more computer programs. When the computer program is loaded and executed on a computer, all or part of the process or function as described in the embodiments of the present disclosure is generated. The computer may be a general-purpose computer, a special-purpose computer, a computer network, or other programmable devices. The computer program may be stored in a computer-readable storage medium or transmitted from one computer-readable storage medium to another. For example, the computer program may be transmitted from one website, computer, server, or data center to another website, computer, server, or data center through wired (such as coaxial cable, optical fiber, digital subscriber line (DSL)) or wireless (such as infrared, wireless, microwave, etc.) means. The computer-readable storage medium may be any available medium accessible by a computer or a data storage device containing one or more available media integrated, such as a server or a data center. The available medium may be a magnetic medium (such as floppy disk, hard disk, magnetic tape), an optical medium (such as high-density digital video disc (DVD)), or a semiconductor medium (such as solid state disk (SSD)), etc.

Those skilled in the art may understand that the first, second, and other various numerical designations in the present disclosure are only for the convenience of description and do not limit the scope of the embodiments of the present disclosure, nor do they indicate any sequence.

“At least one” in the present disclosure may also be described as one or more. “A plurality of” can be two, three, four, or more, and the present disclosure does not impose any restrictions. In the embodiments of the present disclosure, for a certain technical feature, “first”, “second”, “third”, “A”, “B”, “C”, and “D” are used to distinguish the technical features of that technical feature. There is no sequence or size order among the technical features described by “first”, “second”, “third”, “A”, “B”, “C”, and “D”.

The corresponding relationships shown in the tables in the present disclosure may be configured or predefined. The values of the information in the tables are merely examples and may be configured to other values. The present disclosure does not impose any restrictions. When configuring the corresponding relationships between the configuration information and the parameters, it is not necessary to configure all the corresponding relationships indicated in the tables. For example, some rows of the corresponding relationships shown in the tables in the present disclosure may not be configured. Another example is that appropriate modifications and adjustments may be made based on the above tables, such as splitting, merging, etc. The names of the parameters shown in the titles of the above tables may also be other names understandable by the communication apparatus, and the values or representation methods of the parameters may also be other values or representation methods understandable by the communication device. When implementing the above tables, other data structures may also be used, such as arrays, queues, containers, stacks, linear lists, pointers, linked lists, trees, graphs, structures, classes, heaps, hash tables, or hash maps, etc.

“Predefined” in the present disclosure may be understood as defined, predefined, stored, pre-stored, pre-negotiated, pre-configured, solidified, or pre-burned.

Those skilled in the art may appreciate that the units and algorithm steps described in the various examples in the disclosed embodiments may be implemented in electronic hardware, or in a combination of computer software and electronic hardware. Whether the functions are performed in hardware or software depends on the specific application and design constraints of the technical solution. Skilled persons in the art may use different methods to implement the described functions for each specific application, but such implementation should not be considered as beyond the scope of the present disclosure.

Those skilled in the art may clearly understand that for the sake of convenience and conciseness in description, the specific working processes of the systems, devices, and units described above may refer to the corresponding processes in the aforementioned method embodiments, and will not be elaborated here.

The above description is merely a specific implementation of the present disclosure, but the protection scope of the present disclosure is not limited to this. Any skilled in the art may easily think of variations or replacements within the technical scope disclosed by the present disclosure, and all such variations or replacements should be covered within the protection scope of the present disclosure. Therefore, the protection scope of the present disclosure should be determined by the protection scope of the claims.

1. A precoding matrix determination method for uplink multi-input multi-output (MIMO) transmission, executed by a terminal, the method comprising:
receiving a channel status information reference signal (CSI-RS) of 8-antenna ports sent by a network device;
determining a target codeword coefficient adaptive to a current channel state according to the CSI-RS, and sending the target codeword coefficient to the network device;
sending a sounding reference signal (SRS) of 8-antenna ports to the network device;
receiving indication information sent by the network device, wherein the indication information indicates a target precoding matrix required for uplink transmission, the target precoding matrix being determined according to the target codeword coefficient and the SRS; and
precoding data according to the target precoding matrix, and sending pre-coded data to the network device.

2. The method according to claim 1, wherein the determining a target codeword coefficient adaptive to a current channel state according to the CSI-RS comprises:
performing downlink channel estimation according to the CSI-RS; and
determining the target codeword coefficient, by determining a target codeword adaptive to a current channel state according to a result of downlink channel estimation.

3. The method according to claim 1, wherein the method further comprises:
receiving a transmit precoding matrix indicator (TPMI)_sent by the network device, wherein the TPMI is the indication information.

4. The method according to claim 1, wherein the method further comprises:
receiving beam indication sent by the network device, and determining a target beam according to the beam indication, wherein the beam indication is the indication information; and
determining the target precoding matrix according to the target beam and the target codeword coefficient.

5. The method according to claim 1, wherein the sending the target codeword coefficient to the network device comprises:
reporting a codeword coefficient index to the network device, the codeword coefficient index indicating the target codeword coefficient, the target codeword coefficient being at least one coefficient in a candidate codeword coefficient set.

6. The method according to claim 5, wherein the method further comprises:
determining a first bit number required for the codeword coefficient index to occupy according to an antenna structure information; and
reporting the codeword coefficient index to the network device, by occupying the first bit number.

7. The method according to claim 6, wherein the method further comprises:
determining the first bit number occupied by the codeword coefficient index according to a phase angle interval between antennas indicated by the antenna structure information.

8. The method according to claim 1, wherein the target codeword coefficient comprises a common phase coefficient and/or a compensation factor of antenna panel, the method further comprises:
determining the common phase coefficient and the compensation factor of antenna panel in a same way or in different ways.

9. The method according to claim 8, wherein the method further comprises:
determining the common phase coefficient and the compensation factor both according to the CSI-RS; or
determining one of the common phase coefficient and the compensation factor according to the CSI-RS, and determining the other according to the SRS; or
determining one of the common phase coefficient and the compensation factor according to the CSI-RS, and determining the other according to antenna structure information.

10. A precoding matrix determination method for uplink MIMO transmission, executed by a network device, the method comprising:
sending a CSI-RS of 8-antenna ports to a terminal;
receiving a target codeword coefficient sent by the terminal, wherein the target codeword is a codeword coefficient adaptive to a current channel state determined according to the CSI-RS;
receiving an SRS of 8-antenna ports sent by the terminal;
sending indication information to the terminal according to the target codeword coefficient and the SRS, wherein the indication information indicates a target precoding matrix required for uplink transmission; and
receiving data sent by the terminal after precoding according to the target precoding matrix.

11. The method according to claim 10, wherein the method further comprises:
determining an uplink transmission codebook associated with the target codeword coefficient;
determining an optimal precoding matrix from the uplink transmission codebook associated with the target codeword coefficient as the target precoding matrix; and
send a TPMI to the terminal, wherein the TPMI is the indication information.

12. The method according to claim 10, wherein the method further comprises:
determining an uplink transmission codebook associated with the target codeword coefficient;
determining an optimal precoding matrix from the uplink transmission codebook associated with the target codeword coefficient as the target precoding matrix; and
determining a beam corresponding to the target precoding matrix, and sending beam indication to the terminal, wherein the beam indication is the indication information, in order that the target precoding matrix is determined by the terminal according to the beam indication and the target codeword coefficient.

13. The method according to claim 10, wherein the method further comprises:
receiving a codeword coefficient index reported by the terminal, wherein a first bit number occupied by the codeword coefficient index is determined according to antenna structure information; and
determining the target codeword coefficient according to the codeword coefficient index.

14. The method according to claim 13, wherein the first bit number occupied by the codeword coefficient index is determined according to a phase angle interval between antennas indicated by the antenna structure information.

15. The method according to claim 10, wherein the target codeword coefficient comprises a common phase coefficient or a compensation factor of antenna panel, the method further comprises:
the common phase coefficient and the compensation factor of antenna panel are determined in a same way or in different ways.

16. The method according to claim 15, wherein the method further comprises:
determining the common phase coefficient and the compensation factor both according to the CSI-RS; or
determining one of the common phase coefficient and the compensation factor according to the CSI-RS, and determining the other according to the SRS; or
determining one of the common phase coefficient and the compensation factor according to the CSI-RS, and determining the other according to antenna structure information.

17-20. (canceled)

21. A communication apparatus, comprising:
a processor; and
an interface circuit, wherein
the interface circuit is configured to receive code instructions and transmit them to the processor, and
the processor is configured to:
receive a channel status information reference signal CSI-RS of 8-antenna ports sent by a network device;
determine a target codeword coefficient adaptive to a current channel state according to the CSI-RS, and send the target codeword coefficient to the network device;
send a sounding reference signal SRS of 8-antenna ports to the network device;
receive indication information sent by the network device, wherein the indication information used for indicating a target precoding matrix required for uplink transmission, the target precoding matrix being determined according to the target codeword coefficient and the SRS;
pre-code data according to the target precoding matrix; and
send the pre-coded data to the network device.

22. A communication apparatus, comprising:
a processor; and
an interface circuit, wherein
the interface circuit is configured to receive code instructions and transmit them to the processor, and
the processor is configured to execute the method according to claim 1.

23. A non-transitory computer-readable storage medium storing instructions that, when executed by one or more processors of a device, cause the device to implement the method according to claim 1.

24. A non-transitory computer-readable storage medium storing instructions that, when executed by one or more processors of a device, cause the device to implement the method according to claim 10.
